(19) United States
(12) Patent Application Publication
(10) Pub. No.: US 2019/0220956 A1
(43) Pub. Date: Jul. 18, 2019

(54) IMAGE PROCESSING METHOD, IMAGE PROCESSING DEVICE AND NONVOLATILE STORAGE MEDIUM

(71) Applicant: MEGVII TECHNOLOGY LLC, Redmond, WA (US)

(72) Inventors: Jue WANG, Redmond, WA (US); Xue BAI, Redmond, WA (US)

(21) Appl. No.: 15/870,113

(22) Filed: Jan. 12, 2018

(51) Int. Cl. G06T 5/00; G06T 7/11

(52) U.S. Cl. CPC G06T 5/002; G06T 7/11; G06T 2207/20028; G06T 2207/10024; G06T 2207/30088

(57) ABSTRACT

The present disclosure relates to an image processing method, which includes: determining at least one target pixel in an image; determining a set region at the periphery of each target pixel in the at least one target pixel; and sampling pixels in the set region according to a sampling mode as for each of the at least one target pixel, determining a plurality of sampling points, and performing smoothing treatment on the target pixel according to the plurality of sampling points. The method can simplify the computational complexity and increase the computing speed. The present disclosure further provides an image processing device and a nonvolatile storage medium.

### TECHNICAL FIELD

Embodiments of the present disclosure relate to an image processing method, an image processing device corresponding to the method, and a computer-executable nonvolatile storage medium.

### BACKGROUND

Beauty is one of the most commonly used features of many cell phone camera software, including multiple detail technologies such as skin smoothing, blemish removal, wrinkle smoothing, skin whitening and flushing. Among them, skin smoothing is a very important function, which refers to the smoothing of a skin area in an image by digital filtering method, so as to remove or reduce the impurities or wrinkles on the skin.

Bilateral filtering is a well-known effective skin smoothing algorithm. At present, there are some ways to speed up bilateral filtering. However, these methods often adopt the method of exchanging time with space to speed up, and need to store more intermediate variables, so the calculation amount is large, and hence these methods cannot meet the demand of real-time skin smoothing on the mobile phone.

### SUMMARY

The objective of the embodiment of the present disclosure is to provide an image processing method, an image processing device and a nonvolatile storage medium to solve the above technical problems.

According to at least one embodiment of this disclosure, an image processing method is provided, comprising: determining at least one target pixel in an image; determining a set region at the periphery of each target pixel in the at least one target pixel; and sampling pixels in the set region according to a sampling mode as for each of the at least one target pixel, and determining a plurality of sampling points, and performing smoothing treatment on the target pixel according to the plurality of sampling points.

For example, the at least one target pixel is a plurality of target pixels; and the step of sampling the pixels in the set region according to the sampling mode as for each of the at least one target pixel and determining the plurality of sampling points includes: sampling the pixels in respective set regions of at least two target pixels according to different sampling modes as for the at least two target pixels among the plurality of target pixels, and determining a plurality of respective sampling points of the at least two target pixel points.

For example, the step of performing smoothing treatment on the target pixel according to the plurality of sampling points includes: determining the weight of each sampling point in the plurality of sampling points; performing weighted average on the pixel value of the plurality of sampling points according to respective weight of the plurality of sampling points; and correcting the pixel value of the target pixel according to the weighted average result.

For example, the step of determining the weight of each sampling point in the plurality of sampling points includes: calculating the color weight of each sampling point according to the color value of a preset color.

For example, the step of determining the weight of each sampling point in the plurality of sampling points includes: determining the distance from each sampling point in the plurality of sampling points of the target pixel to the target pixel according to the sampling mode of each target pixel in the at least one target pixel; and calculating the time domain weight of each sampling point according to the distance.

For example, the step of determining the weight of each sampling point in the plurality of sampling points includes: calculating the weight of each sampling point according to the following formula: Wᵢ=Wᵢ^{s}·max(0, 255−|gᵢ−g_{c}|*C), wherein, Wᵢ refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel; and C is a constant within a preset range.

For example, the step of performing weighted average on the pixel value of the plurality of sampling points according to respective weight of the plurality of sampling points includes: determining the sum of the weight of the plurality of sampling points to be 2^{K}, in which K refers to a preset value relevant to the number of the sampling points and the time domain weight of each sampling point; and performing weighted average on the pixel value of the plurality of sampling points according to the weight sum.

For example, the step of determining at least one target pixel in the image includes: determining whether the pixel value of the pixel in the image satisfies preset conditions; and determining at least one pixel, satisfying the preset conditions, in the image to be the at least one target pixel.

For example, the pixel in the image is I_{c}={r_{c}, g_{c}, b_{c}}, and the preset conditions are: r_{c}>N and b_{c}<g_{c}<r_{c}, wherein, r_{c} refers to the color value of a red channel of the pixel; g_{c} refers to the color value of a green channel of the pixel; b_{c} refers to the color value of a blue channel of the pixel; and N is an integer within the range of [70, 130].

For example, as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

According to at least one embodiment of this disclosure, an image processing device is provided, comprising: a memory and a processor, wherein program instructions are stored in the memory; and the processor executes the following steps while applying the program instructions: determining at least one target pixel in an image; determining a set region at the periphery of each target pixel in the at least one target pixel; and sampling pixels in the set region according to a sampling mode as for each of the at least one target pixel, determining a plurality of sampling points, and performing smoothing treatment on the target pixel according to the plurality of sampling points.

For example, the at least target pixel is a plurality of target pixels; and the processor further executes the following step while applying the program instructions: sampling pixels in respective set regions of at least two target pixels according to different sampling modes as for the at least two target pixels among the plurality of target pixels, and determining a plurality of respective sampling points of the at least two target pixels.

For example, the processor further executes the following step while applying the program instructions: determining the weight of each sampling point in the plurality of sampling points; performing weighted average on the pixel value of the plurality of sampling points according to respective weight of the plurality of sampling points; and correcting the pixel value of the target pixel according to the weighted average result.

For example, the processor further executes the following step while applying the program instructions: calculating the color weight of each sampling point according to the color value of a preset color.

For example, the processor further executes the following step while applying the program instructions: determining the distance from other sampling points, except the target pixel, in the plurality of sampling points of the target pixel to the target pixel according to the sampling mode of each target pixel in the at least one target pixel; and calculating the time domain weight according to the distance.

For example, the processor further executes the following step while applying the program instructions: calculating the weight of each sampling point according to the following formula: Wᵢ=Wᵢ^{s}·max(0, 255−|gᵢ−g_{c}|*C), wherein, Wi refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel; and C is a constant within a preset range.

For example, as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

According to at least one embodiment of this disclosure, a computer-executable nonvolatile storage medium is provided, storing computer program instructions, and executing the following steps when the computer program instructions are loaded by a processor: determining at least one target pixel in an image; determining a set region at the periphery of each target pixel among the at least one target pixel; and sampling pixels in the set region according to a sampling mode as for each of the at least one target pixel, determining a plurality of sampling points, and performing smoothing treatment on the target pixel according to the plurality of sampling points.

For example, the at least one target pixel is a plurality of target pixels; and the following step is further executed when the computer program instructions are loaded by the processor: sampling the pixels in respective set regions of at least two target pixels according to different sampling modes as for the at least two target pixels among the plurality of target pixels, and determining a plurality of respective sampling points of the at least two target pixel points.

For example, as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

The image processing method and the image processing device, provided by the embodiment of the present disclosure, can significantly simplify the computational complexity and increase the computing speed.

### BRIEF DESCRIPTION OF THE DRAWINGS

Simple description will be given below to the accompanying drawings required to be used in the description of the embodiments to provide a more clear understanding of the technical proposals of the embodiments of the present disclosure. Obviously, the drawings described below only involve the exampled embodiments of the present disclosure.

FIG. 1 is a flow diagram of an image processing method provided by the embodiment of the present disclosure;

FIGS. 2a-2b are schematic diagrams of target pixels and sampling points in the embodiment of the present disclosure;

FIG. 3a is a schematic diagram of smoothing filter input and output images;

FIG. 3b is a schematic diagram of another smoothing filter input and output image;

FIG. 4 is an image processing device provided by the embodiment of the present disclosure; and

FIG. 5 is another image processing device provided by the embodiment of the present disclosure.

### DETAILED DESCRIPTION

Detailed description will be given below to the preferred embodiments of the present disclosure with reference to the accompanying drawings. It should be noted that: in the description and the drawings, basically same steps and elements are represented by same reference numerals of the accompanying drawings, and the repeated explanation on these steps and elements is omitted.

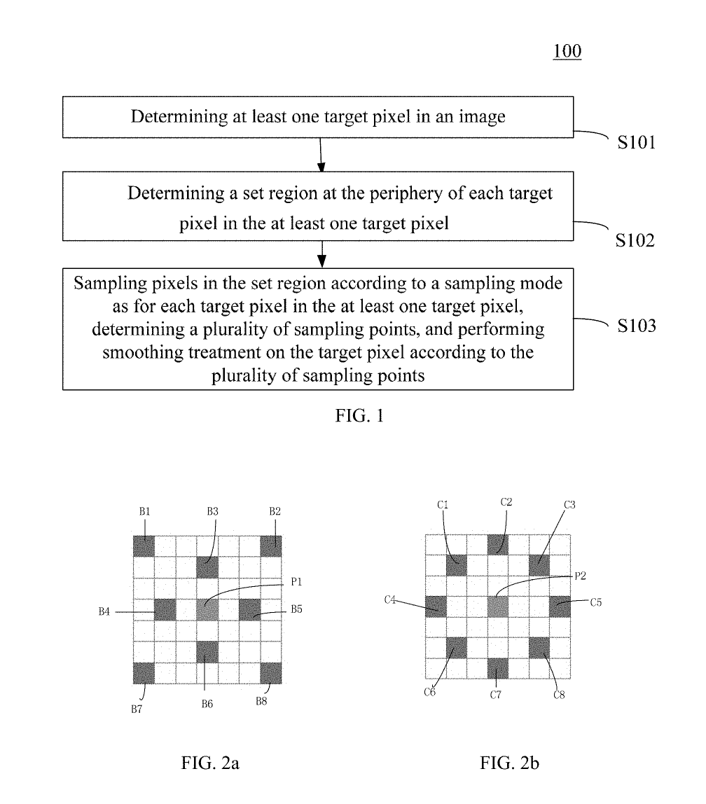

FIG. 1 shows an image processing method 100 provided by the embodiment of the present disclosure. As illustrated in FIG. 1, the image processing method 100 may comprise the following steps S101, S102 and S103.

S101: determining at least one target pixel in an image. There are a plurality of pixels in one image. One or more pixels may be determined as the target pixels, so as to perform smoothing treatment on the determined one or more target pixels subsequently, and hence the skin smoothing effect can be achieved. Before S101, the method 100 may further include: obtaining an image. For example, acquiring an image by an image acquiring apparatus (such as a camera), or obtaining a pre-stored image from a memory.

FIGS. 2a-2b are schematic diagrams of target pixels and sampling points corresponding to the target pixels in the embodiment of the present disclosure. As shown in FIG. 2a, P1 is a determined target pixel. As shown in FIG. 2b, P2 is another determined target pixel.

According to one example of the present disclosure, in the process of determining the target pixel in the image, whether the pixel value of the pixel in the image satisfies preset conditions may be determined, and one or more pixels, satisfying the preset conditions, in the image may be determined as the target pixels. Thus, the calculation amount can be reduced by precluding some pixels. The preset conditions may be used for distinguishing an area-of-interest and other areas in the image. Pixels disposed in the area-of-interest can be determined by adoption of one or more pixels satisfying the preset conditions as the target pixels. For instance, supposing the pixel in the image is represented by I_{c}={r_{c}, g_{c}, b_{c}}, in which r_{c} refers to the color value of a red channel of the pixel I_{c}; g_{c} refers to the pixel value of a green channel of the pixel I_{c}; b_{c} refers to the color value of a blue channel of the pixel I_{c}, the preset conditions may be r_{c}>N and b_{c}<g_{c}<r_{c}, in which N may be any integer with the range of [70, 130]. For instance, N may take a value of 100. As the color of the pixel value satisfying the preset conditions belongs to the skin color or is close to the skin color, after the step of filtering the pixels according to the preset conditions, non-skin pixels may be precluded, namely directly skipped in the filtering process, so the calculation amount is reduced and the computing speed of the algorithm is increased.

However, the preset conditions for selecting the target pixels are more suitable for Asian color and not suitable for other colors. Appropriate preset conditions may be set according to specific skin color of the area-of-interest. According to another example of the present disclosure, the preset conditions may also be: r_{c}>95 & g_{c}>40 & b_{c}>20 & r_{c}>g_{c} & r_{c}>b_{c} & Max(r_{c},g_{c},b_{c})−Min(r_{c},g_{c},b_{c})>15 and Abs(r_{c}−g_{c})>15, in which Max refers to the maximum; Min refers to the minimum; and Abs refers to the absolute value. The settings of the above preset conditions are only illustrative. The pixels in the image may also be filtered by those skilled in the art by determining other preset conditions according to actual conditions.

S102: determining a set region at the periphery of each target pixel in the at least one target pixel. According to one example of the present disclosure, as the human face also includes eyes, eyelashes and other parts in addition to the skin area, in order to effectively protect effective high-frequency characteristics of the face area, for instance, for the areas such as the eyelashes and the eyes to be not affected by the image processing method provided by the present disclosure and be kept clear, the set region at the periphery of the target pixel may be selected as a smoothing filter area. The set region may exclude the high-frequency characteristics such as the eyelashes and the eyes. The set region at the periphery of the target pixel, for instance, may be an area, including one or more pixels, on the upper, lower, left and/or right side of the target pixel. For instance, the set region at the periphery of each target pixel may be a rectangular region taking the target pixel as the center and taking preset side length as the side length. For instance, as shown in FIGS. 2a and 2b, a rectangular region, taking each target pixel P1 or P2 as the center and taking 7 pixel widths as the side length, may be determined as the set region. Of course, a rectangular region, taking each target pixel P1 or P2 as the center and taking 5 pixel widths as the side length, may also be determined as the set region.

S103: sampling pixels in the set region according to a sampling mode as for each target pixel in the at least one target pixel, determining a plurality of sampling points, and performing smoothing treatment on the target pixel according to the plurality of sampling points. In the embodiment of the present disclosure, sampling refers to the acquisition of partial pixels, not all the pixels, in the plurality of pixels. Thus, as the sample number is less than the number of all the pixels in the set region, the image processing method provided by the embodiment of the present disclosure can reduce the calculation amount.

If all the target pixels adopt the same sampling mode, some visible defects in the checkerboard format may appear in an image outputted after smoothing treatment. In order to reduce the defects, according to one example of the present disclosure, when there are a plurality of target pixels, as for at least two target pixels in the plurality of target pixels, pixels in respective set regions of the at least two target pixels are sampled according to different sampling modes, so as to determine a plurality of respective sampling points of the at least two target pixels. For instance, as for two adjacent target pixels, different sampling modes are adopted for sampling. That is to say, in the embodiment of the present disclosure, the at least two target pixels have different sampling modes. Different sampling modes select different sampling points from the same area. For instance, as shown in FIGS. 2a and 2b, in FIG. 2a, as for the target pixel P1, the first sampling mode is adopted to sample pixels in a set region of P1, namely taking B1-B8 as the sampling points of P1; and in FIG. 2b, as for the target pixel P2, the second sampling mode is adopted to sample pixels in a set region of P2, namely taking C1-C8 as the sampling points of P2. In the embodiment of the present disclosure, the at least two target pixels in the plurality of target pixels select different sampling modes. As different target pixels adopt different sampling modes, same filter error can be difficult to occur, so some regular visual defects can be effectively avoided. In another embodiment of the present disclosure, the plurality of target pixels adopt different sampling modes, so some regular visual defects can be further avoided.

According to one example of the present disclosure, the set region at the periphery of each target pixel includes the region in which the target pixel is located. The plurality of sampling points of each target pixel may include the target pixel. That is to say, in the process of determining the sampling points of each target pixel, the adopted sampling mode may take the target pixel as one sampling point. Thus, the color of the target pixel after smoothing filter and the original color of the target pixel will not be too deviated, so the image quality after smoothing filter can be improved.

In the embodiment of the present disclosure, after the process of sampling the pixels in the set region of each target pixel, the target pixel may be subjected to smoothing treatment according to the plurality of sampling points. According to one example of the present disclosure, in the smoothing process, the pixel value of the plurality of sampling points may be subjected to weighted average at first, and then the pixel value of the target pixel is corrected according to the weighted average result.

For instance, in the process of performing weighted average on the pixel value of the plurality of sampling points, the weight of each sampling point in the plurality of sampling points may be determined at first, and then the pixel value of the plurality of sampling points is subjected to weighted average according to respective weight of the plurality of sampling points. The weight of each sampling point may be obtained by calculating the color weight and the time domain weight of each sampling point. The color weight of the sampling point is, for instance, relevant to the color difference between the sampling point and the target pixel. In general, when the color difference is larger, the color weight is smaller; and when the color difference is smaller, the color weight is larger. The time domain weight of the sampling point is, for instance, relevant to the space distance from the sampling point to the target pixel.

In the process of performing smoothing treatment on the target pixel by weighted average of the plurality of sampling points, the following formula (1) may be adopted to calculate the pixel value of each target pixel in an output image I_{D}(i, j):

$${I}_{D} ( i , j ) = \frac{{\sum }_{k , l} I ( k , l ) w ( i , j , k , l )}{{\sum }_{k , l} w ( i , j , k , l )} , \qquad ( 1 )$$

wherein, as for each target pixel with the coordinate value of (i, j), I_{D}(i, j) refers to the pixel value of a target pixel at the position of the coordinate (i, j) in an image obtained after smoothing filter; I(k, l) refers to the pixel value of a sampling point, corresponding to the target pixel (i, j), at the position of the coordinate (k, l); and w(i, j, k, l) refers to the weight of the sampling point (k, l) of the target pixel (i, j).

In one embodiment of the present disclosure, the weight of each sampling point in the denominator of the above formula (1) may be calculated according to the following formula (2):

$$w ( i , j , k , l ) = exp ( - \frac{{( i - k )}^{2} + {( j - l )}^{2}}{2 {σ}_{d}^{2}} - \frac{{‖ I ( i , j ) - I ( k , l ) ‖}^{2}}{2 {σ}_{r}^{2}} ) , \qquad ( 2 )$$

wherein, δ_{d} and δᵣ respectively represent the variance of Gaussian functions of the image in a coordinate space and a color space.

In the embodiment, the calculation of the weight of each sampling point involves the calculation of two distances in a time domain space and a color space and the calculation of one exponential function, so the calculation amount is large.

Therefore, in order to reduce the calculation amount and increase the computing speed, in another embodiment of the present disclosure, the following method is adopted to calculate the weight.

Firstly, in the process of determining the color weight of each sampling point in the plurality of sampling points, the color weight of each sampling point may be calculated according to the color value of one or more preset colors. Wherein, the preset color may be the color with the most difference between the skin color of the human face and other objects in the surroundings. As the skin color of the human face in a green channel often has the greatest difference with the colors of other objects in the surroundings in actual skin smoothing application, the color weight of each sampling point may be calculated according to the color value of the green channel, and the color value of other colors is not considered. That is to say, the color weight of each sampling point is determined only according to the color difference between the color value of the green channel of each sampling point and the target pixel. For instance, when the color difference is smaller, the weight is larger; and when the color difference is larger the weight is smaller.

In addition, in the process of determining the time domain weight of each sampling point in the plurality of sampling points, as each target pixel adopts fixed sampling mode in the embodiment of the present disclosure, the distance between the plurality of sampling points of the target pixel and the target pixel may be determined according to the sampling mode of each target pixel, and the time domain weight may be calculated according to the determined distance. In general, when the distance to the target pixel is closer, the time domain weight of the sampling point is larger; and when the distance to the target pixel is farther, the time domain weight of the sampling point is smaller. For instance, as shown in FIG. 2a, the distance from B3, B4, B5 and B6 to the target pixel P1 is closer to the distance from B1, B2, B7 and B8 to the target pixel P1, so the time domain weight of B3, B4, B5 and B6 is greater than the time domain weight of B1, B2, B7 and B8.

After the step of determining the color weight and the time domain weight of each sampling point, the weight of each sampling point may be calculated according to the following formula (3):

Wᵢ=Wᵢ^{s}·max(0, 255−|gi−gc|*C) (3)

wherein, Wᵢ refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel corresponding to the sampling point; and max(0, 255−|gᵢ−g_{c}|*C) refers to the color weight of the i^{th} sampling point. In the embodiment of the present disclosure, the above color values may be set to be integers with the range of [0-255]. In addition, C is a constant within a preset range, for instance, taking a value within the range of [5, 10].

In the foregoing smoothing filter method, namely in the formula (1), one division operation must be executed. Division is the slowest operation. In order to avoid the division operation, according to one example of the present disclosure, the weighted average operation of the sampling point may be adjusted to be integer operation, so as to avoid the use of floating point numbers, and hence improve the computational efficiency.

In addition, in the embodiment of the present disclosure, when the target pixel is also included in the example of the sampling point, as for sampling points except the target pixel, the weight may be calculated according to the method in the formula (3), and the sum of the weight of these sampling points may be determined as γ. As for the target pixel, the weight may be set to be 2^{k}−γ. Thus, 2^{k} is obtained by the addition of the weight of all the sampling points of one target pixel, namely the denominator is 2^{k} in the formula (1). Thus, the pixel value of the plurality of sampling points may be subjected to weighted average according to the weight sum 2^{K}. That is to say, rapid calculation may be performed by k-bit right shift method in the case of division operation.

According to one example of the present disclosure, the value of k is relevant to the number of the sampling points. In addition, the value of K is also relevant to the precalculated time domain weight of the sampling point in the formula (3). Therefore, the value of K may be preset according to the number of the sampling points and the time domain weight of the sampling points. For instance, supposing the number of the sampling points excluding the target pixel is n, the time domain weight Wᵢ^{s} of the i^{th} sampling point in the formula (3) may be set to be a constant

$$\frac{2}{3 n} ,$$

the possible maximum of the weight sum γ of the n sampling points is 170, and at this point, the value of k may be 8.

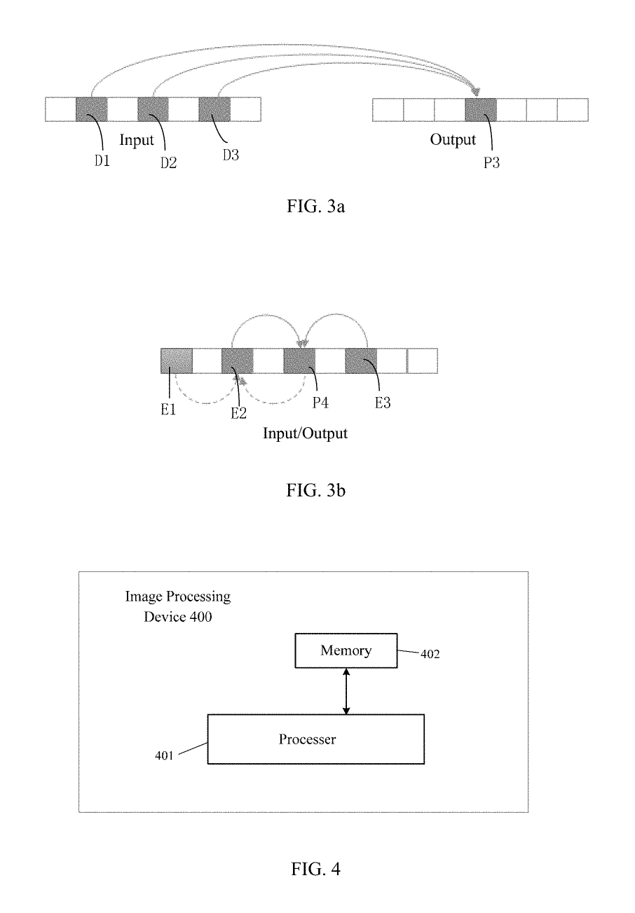

In addition, in the smoothing filter process, an image required for smoothing filter is taken as input data and inputted into a smoothing filter algorithm, and an output image after smoothing filter is obtained. FIG. 3a is a schematic diagram of smoothing filter input and output images. FIG. 3b is a schematic diagram of another smoothing filter input and output image.

In one embodiment of the present disclosure, memory blocks of an input image and an output image are separate, namely input data and output data are separate. For instance, as shown in FIG. 3a, the input data and the output data are separate, and a target pixel P3 in the output image is the weighted average of 3 sampling points D1-D3 in the input image. In the embodiment, the filtering result of each target pixel is not affected by the filtering result of other target pixels.

In another embodiment of the present disclosure, the input image and the output image may share one memory block, namely the input data and the output data may perform recursive filtering on each target pixel in the input image sequentially according to specific sequence (e.g., from the top down or from left to right). That is to say, as for one or more target pixels not subjected to smoothing treatment in the at least one target pixel, the plurality of sampling points obtained after sampling the pixels in respective set regions at the periphery of the one or more target pixels include the target pixels obtained after smoothing treatment. For instance, as shown in FIG. 3b, recursive filtering is performed on each target pixel in the input image sequentially according to the sequence from left to right; in the process of performing smoothing filter on P4 in the input image, three sampling points E2, E3 and P4 are selected; the target pixel P4 in the output image is obtained by calculation; and the sampling point E2 is a target pixel obtained after smoothing filter according to E1 and P4. Thus, although the three sampling points are adopted for input as for the target pixel P4 in the smoothing filter image as shown in FIG. 3b, because one sampling point is a target pixel obtained after filtering, it is equivalent to the use of pixel information of a sampling point corresponding to the target pixel after filtering, so it is equivalent to the implied use of pixel information of more sampling points on the premise of not increasing the computing speed and the computational complexity. Therefore, the result of more sampling points can be approximated as much as possible via recursive filtering adopted in the embodiment of the present disclosure, so the effectiveness of the smoothing filter algorithm can be improved and the smoothing filter effect of the image can be better.

The image processing method provided by the embodiment of the present disclosure does not require an additional storage space and only needs to do operation in the memory block of the input image, and meanwhile has rapid operational speed due to algorithm simplification. In actual measurement, an image with the size of 720*1280 in full screen processed on iPhone 6 Plus only requires the computing time of about 8 ms. Moreover, the method can achieve effective skin smoothing effect in actual application and has high practical value.

The image processing method provided by the embodiment of the present disclosure has been described above. Further description will be given below to the image processing device provided by the embodiment of the present disclosure. The image processing device corresponds to the foregoing image processing method. Simple description is only given below for the clarity of the description. More specific content may refer to the content in the above embodiments.

FIG. 4 shows an image processing device 400 provided by the embodiment of the present disclosure. As illustrated in FIG. 4, the image processing device 400 comprises a memory 401 and a processor 402. The processor 402 may, for instance, be a general purpose processor such as a central processing unit (CPU) or a graphics processing unit (GPU) or a special purpose processor such as a programmable logic circuit. Program instructions are stored in the memory 401. The processor 402 executes the following steps while applying the program instructions: determining at least one target pixel in an image; determining a set region at the periphery of each target pixel in the at least one target pixel; and sampling pixels in the set region according to a sampling mode as for each of the at least one target pixel, determining a plurality of sampling points, and performing smoothing treatment on the target pixel according to the plurality of sampling points.

In one embodiment of the present disclosure, the at least one target pixel is a plurality of target pixels, and the processor 402 further executes the following step while applying the program instructions: sampling pixels in respective set regions of at least two target pixels according to different sampling modes as for the at least two target pixels in the plurality of target pixels, and determining a plurality of respective sampling points of the at least two target pixels.

In one embodiment of the present disclosure, the processor 402 further executes the following step while applying the program instructions: determining the weight of each sampling point in the plurality of sampling points; performing weighted average on the pixel value of the plurality of sampling points according to respective weight of the plurality of sampling points; and correcting the pixel value of the target point according to the weighted average result.

In one embodiment of the present disclosure, the processor 402 further executes the following step while applying the program instructions: calculating the color weight of each sampling point according to the color value of a preset color.

In one embodiment of the present disclosure, the processor 402 further executes the following step while applying the program instructions: determining the distance from other sampling points, except the target point, in the plurality of sampling points of the target pixel to the target pixel according to the sampling mode of each target pixel in the at least one target pixel; and calculating the time domain weight of each sampling point according to the distance.

In one embodiment of the present disclosure, the processor 402 further executes the following step while applying the program instructions: calculating the weight of each sampling point according to the following formula:

Wi=Wᵢ^{s}·max(0, 255−|gᵢ−g_{c}|*C)

wherein, Wi refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel; and C is a constant within a preset range.

In one embodiment of the present disclosure, as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

The image processing device provided by the embodiment of the present disclosure obviously reduces the calculation amount and improves the operational efficiency as the sample number is less than the number of all the samples in the set region.

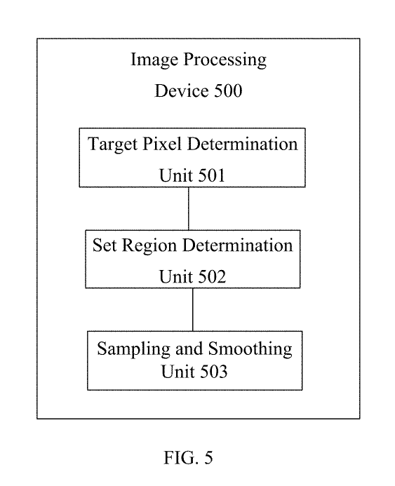

Another embodiment of the present disclosure further provides an image processing device corresponding to the foregoing image processing method. FIG. 5 shows the image processing device 500 provided by the embodiment of the present disclosure. As illustrated in FIG. 5, the image processing device 500 comprises a target pixel determination unit 501, a set region determination unit 502 and a sampling and smoothing unit 503. The target pixel determination unit 501 is configured to determine at least one target pixel in an image; the set region determination unit 502 is configured to determine a set region at the periphery of each target pixel in the at least one target pixel; and the sampling and smoothing unit 503 is configured to sample pixels in the set region according to a sampling mode as for each of the at least one target pixel, determine a plurality of sampling points, and perform smoothing treatment on the target pixel according to the plurality of sampling points. The above three units may be implemented by software, hardware or firmware, for instance, be implemented by a CPU, a programmable logic circuit, etc.

The image processing device provided by the embodiment of the present disclosure obviously increases the computing speed as the number of the sampling points is reduced and the algorithm is simplified.

Another embodiment of the present disclosure further provides a computer-executable nonvolatile storage medium corresponding to the foregoing image processing method. The nonvolatile storage medium may also refer to the content in the foregoing image processing method. The nonvolatile storage medium stores computer program instructions, and executes the following steps when a processor applies the computer program instructions: determining at least one target pixel in an image; determining a set region at the periphery of each target pixel in the at least one target pixel; and sampling pixels in the set region according to a sampling mode as for each of the at least one target pixel, determining a plurality of sampling points, and performing smoothing treatment on the target pixel according to the plurality of sampling points.

In one embodiment of the present disclosure, the at least one target pixel is a plurality of target pixels, and the following step is further executed when the processor applies the computer program instructions:

sampling pixels in respective set regions of at least two target pixels according to different sampling modes as for the at least two target pixels in the plurality of target pixels, so as to determine a plurality of respective sampling points of the at least two target pixels.

In one embodiment of the present disclosure, as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

The skilled in the art may realize that, the units and arithmetic process in each example described with the embodiments disclosed in this disclosure can be achieved through electronic hardware, computer software or the combination of the both. Also, the software module may be set in any kinds of computer mediums. In order to describe clearly the interchangeability of hardware and software, the constitution and steps of each example have been described generally in terms of function in the description above. These functions are implemented with hardware or software is due to the specific application and design restriction condition of the technical solution. The skilled in the art may use different method to achieve the described function pointing to each specific application, however, the achievement should not be considered over the scope of this disclosure.

Those skilled in the art should appreciate that various modifications, combinations, sub-combinations and substitutions may be done depending on design requirements and other factors as long as they fall within the scope of the accompanying claims and their equivalents.

1. An image processing method, comprising:
determining at least one target pixel in an image;
determining a set region at the periphery of each target pixel in the at least one target pixel; and
sampling pixels in the set region according to a sampling mode as for each of the at least one target pixel, and determining a plurality of sampling points, and performing smoothing treatment on the target pixel according to the plurality of sampling points.

2. The method according to claim 1, wherein the at least one target pixel is a plurality of target pixels; and
the step of sampling the pixels in the set region according to the sampling mode as for each of the at least one target pixel and determining the plurality of sampling points includes:
sampling the pixels in respective set regions of at least two target pixels according to different sampling modes as for the at least two target pixels among the plurality of target pixels, and determining a plurality of respective sampling points of the at least two target pixel points.

3. The method according to claim 1, wherein the step of performing smoothing treatment on the target pixel according to the plurality of sampling points includes:
determining the weight of each sampling point in the plurality of sampling points;
performing weighted average on the pixel value of the plurality of sampling points according to respective weight of the plurality of sampling points; and
correcting the pixel value of the target pixel according to the weighted average result.

4. The method according to claim 3, wherein the step of determining the weight of each sampling point in the plurality of sampling points includes:
calculating the color weight of each sampling point according to the color value of a preset color.

5. The method according to claim 3, wherein the step of determining the weight of each sampling point in the plurality of sampling points includes:
determining the distance from each sampling point in the plurality of sampling points of the target pixel to the target pixel according to the sampling mode of each target pixel in the at least one target pixel; and
calculating the time domain weight of each sampling point according to the distance.

6. The method according to claim 3, wherein the step of determining the weight of each sampling point in the plurality of sampling points includes:
calculating the weight of each sampling point according to the following formula:
Wᵢ=Wᵢ^{s}·max(0, 255−|gᵢ−g_{c}|*C)
wherein, Wᵢ refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel; and C is a constant within a preset range.

7. The method according to claim 3, wherein
the step of performing weighted average on the pixel value of the plurality of sampling points according to respective weight of the plurality of sampling points includes:
determining the sum of the weight of the plurality of sampling points to be 2^{K}, in which K refers to a preset value relevant to the number of the sampling points and the time domain weight of each sampling point; and
performing weighted average on the pixel value of the plurality of sampling points according to the weight sum.

8. The method according to claim 1, wherein the step of determining at least one target pixel in the image includes:
determining whether the pixel value of the pixel in the image satisfies preset conditions; and
determining at least one pixel, satisfying the preset conditions, in the image to be the at least one target pixel.

9. The method according to claim 8, wherein the pixel in the image is I_{c}={r_{c}, g_{c}, b_{c}}, and the preset conditions are:
r_{c}>N and b_{c}<g_{c}<r_{c}
wherein, r_{c} refers to the color value of a red channel of the pixel; g_{c} refers to the color value of a green channel of the pixel; b_{c} refers to the color value of a blue channel of the pixel; and N is an integer within the range of [70, 130].

10. The method according to claim 1, wherein as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

11. An image processing device, comprising: a memory and a processor, wherein program instructions are stored in the memory; and the processor executes the following steps while applying the program instructions:
determining at least one target pixel in an image;
determining a set region at the periphery of each target pixel in the at least one target pixel; and
sampling pixels in the set region according to a sampling mode as for each of the at least one target pixel, determining a plurality of sampling points, and performing smoothing treatment on the target pixel according to the plurality of sampling points.

12. The device according to claim 11, wherein the at least target pixel is a plurality of target pixels; and
the processor further executes the following step while applying the program instructions:
sampling pixels in respective set regions of at least two target pixels according to different sampling modes as for the at least two target pixels among the plurality of target pixels, and determining a plurality of respective sampling points of the at least two target pixels.

13. The device according to claim 11, the processor further executes the following step while applying the program instructions:
determining the weight of each sampling point in the plurality of sampling points;
performing weighted average on the pixel value of the plurality of sampling points according to respective weight of the plurality of sampling points; and
correcting the pixel value of the target pixel according to the weighted average result.

14. The device according to claim 13, wherein the processor further executes the following step while applying the program instructions:
calculating the color weight of each sampling point according to the color value of a preset color.

15. The device according to claim 13, wherein the processor further executes the following step while applying the program instructions:
determining the distance from other sampling points, except the target pixel, in the plurality of sampling points of the target pixel to the target pixel according to the sampling mode of each target pixel in the at least one target pixel; and
calculating the time domain weight according to the distance.

16. The device according to claim 13, wherein the processor further executes the following step while applying the program instructions:
calculating the weight of each sampling point according to the following formula:
Wᵢ=Wᵢ^{s}·max(0, 255−|gᵢ−g_{c}|*C)
wherein, Wᵢ refers to the weight of the i^{th} sampling point; Wᵢ^{s} refers to the time domain weight of the i^{th} sampling point; gᵢ refers to the color value of a green channel of the i^{th} sampling point; g_{c} refers to the color value of a green channel of the target pixel; and C is a constant within a preset range.

17. The device according to claim 11, wherein as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.

18. A computer-executable nonvolatile storage medium, storing computer program instructions, and executing the following steps when the computer program instructions are loaded by a processor:
determining at least one target pixel in an image;
determining a set region at the periphery of each target pixel among the at least one target pixel; and
sampling pixels in the set region according to a sampling mode as for each of the at least one target pixel, determining a plurality of sampling points, and performing smoothing treatment on the target pixel according to the plurality of sampling points.

19. The computer-executable nonvolatile storage medium according to claim 18, wherein the at least one target pixel is a plurality of target pixels; and
the following step is further executed when the computer program instructions are loaded by the processor:
sampling the pixels in respective set regions of at least two target pixels according to different sampling modes as for the at least two target pixels among the plurality of target pixels, and determining a plurality of respective sampling points of the at least two target pixel points.

20. The computer-executable nonvolatile storage medium according to claim 18, wherein as for one or more target pixels not subjected to smoothing treatment in the at least one target pixel, the plurality of sampling points, obtained by sampling the pixels in respective set regions at the periphery of the one or more target pixels, include target pixels obtained after smoothing treatment.
